(19) United States
(12) Patent Application Publication
(10) Pub. No.: US 2021/0332643 A1
(43) Pub. Date: Oct. 28, 2021

(54) EXTENSIBLE LADDER

(71) Applicant: Dorel Home Furnishings, Inc., Wright City, MO (US)

(72) Inventors: Evan A. Brown, Campbellsburg, IN (US); Kyle J. Lawrence, Greenfield, IN (US); Jason A. Boyer, Columbus, IN (US)

(21) Appl. No.: 17/241,739

(22) Filed: Apr. 27, 2021

Related U.S. Application Data
(60) Provisional application No. 63/016,679, filed on Apr. 28, 2020.

(51) Int. Cl. E06C 1/12; E06C 7/14; E06C 7/48

(52) U.S. Cl. CPC E06C 1/125; E06C 7/48; E06C 7/14

(57) ABSTRACT

An adjustable-height ladder includes left and right legs and a series of horizontal steps coupled to the left and right legs. The ladder also includes a utility tray.

### PRIORITY CLAIM

This application claims priority under 35 U.S.C. § 119(e) to U.S. Provisional Application No. 63/016,679 filed Apr. 28, 2020, which is expressly incorporated by reference herein.

### BACKGROUND

The present disclosure relates to a ladder and in particular to a collapsible ladder. More particularly, the present disclosure relates to a telescoping ladder having a top tray.

### SUMMARY

A ladder in accordance with the present disclosure includes first and second side legs and steps extending laterally between the side legs. In illustrative embodiments, the ladder further includes telescopic first and second side legs and a top tray coupled to free ends of each of the telescopic first and second side legs. The top tray has a perimeter rim that is configured to included two corner-lean surfaces that mate with two walls forming a corner of a room to allow the ladder to lean in the corner and a medial wall-lean surface located between the corner-lean surfaces to allow the ladder to lean against a single wall.

In illustrative embodiments, the ladder includes a leg foundation adapted to rest on an underlying surface, a top tray located above the leg foundation, and a variable-length tray-extension unit interconnecting the leg foundation and the top tray. The tray-extension unit includes an uppermost step rung located just below the top tray. A rung is one of the horizontal steps of a ladder and has a long length and relatively narrow width (i.e. depth). The top tray including its perimeter rim is sized in accordance with the present disclosure to fit within a length and width footprint established by the uppermost step rung of the tray-extension unit so that the size of the top tray is about the same as the size of the uppermost rung.

In illustrative embodiments, the tray-extension unit includes separate left and right telescoping legs arranged to lie in spaced-apart parallel relation to one another and to interconnect the leg foundation and the top tray. A series of step rungs (including the uppermost step rung) is arranged to interconnect leg segments of varying diameter included in the telescoping left and right legs. The top tray is mounted on upwardly facing exposed free ends of the left and right telescoping legs of tray-extension unit to overlie the uppermost step rung.

In illustrative embodiments, each step rung is configured to include an ergonomic left finger grip at one end and a companion ergonomic right finger grip at an opposite end. Each pair of finger grips in a step rung are arranged to extend outwardly in opposite directions to help a user grip the step rung to assist with lengthening and shortening the variable-length tray-extension unit during a change in the ladder between a COLLAPSED-STORAGE mode in which the top tray and the underlying step rungs are bunched together owing to telescoping contraction of each of the left and right telescoping legs to shorten the ladder for easy storage and an EXTENDED-USE mode in which the top tray and the underlying step rungs are spaced apart owing to telescoping expansion of each of the left and right telescoping legs to lengthen the ladder for use to reach elevated items and places. Each step rung also includes a step arranged to lie between the companion ergonomic left and right finger grips, a left leg mount interconnecting the ergonomic left finger grip and one end of the step and mating with a leg section in the left telescoping leg, and a right leg mount interconnecting the ergonomic right finger grip and an opposite end of the step and mating with the right telescoping leg.

In illustrative embodiments, the top tray includes a shelf that is formed to include an upwardly opening article-receiving cavity and a perimeter rim that extends around an exterior edge of the shelf. The perimeter rim includes back and front wall-engagement shields made in accordance with the present disclosure. Each such wall-engagement shield is configured to have two separated substantially flat corner-lean surfaces and each flat corner-lean surface is arranged to engage one of two adjacent walls when the ladder is leaned against two such walls in a corner of a room. Each such wall-lean shield also includes a flat medial wall-engagement surface located between the two corner-lean surfaces that is arranged to engage a single wall when the ladder is leaned against that wall.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of an extensible ladder in accordance with the present disclosure shown in a COLLAPSED-STORAGE mode showing that the extensible ladder includes a top tray, a leg foundation underlying the top tray, and a variable-length tray-extension unit interconnecting the leg foundation and the top tray and showing that the top tray has a perimeter rim including corner-lean surfaces and medial wall-lean surfaces that are shown in more detail in FIG. 2A;

FIG. 2 is a reduced-size view of the extensible ladder of FIG. 1 shown in an alternative EXTENDED-USE mode in which two of the corner-lean surfaces of the top tray mate with two walls when the ladder is leaned in a corner formed by the two walls as suggested in FIGS. 19, 20, and 25 and one of the medial wall-lean surfaces mates with a single wall when the ladder is leaned against that wall as suggested in FIGS. 16-18 and showing that the leg foundation is adapted to engage an underlying floor, the variable-length tray-extension unit includes left and right telescoping legs arranged to interconnect the leg foundation and the top tray and configured to be operated by a person to move the top tray relative to the leg foundation from a LOWERED position shown in FIG. 1 to a RAISED position shown in FIG. 2, and further showing that the extensible ladder further includes a series of movable step rungs each mounted on a companion pair of tubular leg segments to allow relative movements of the movable step rungs from SIDE-BY-SIDE positions occupied in the COLLAPSED-STORAGE mode of the ladder as shown in FIG. 1 to SEPARATED positions occupied in the EXTENDED-USE mode of the ladder as shown in FIG. 2 to cause the top tray to have the same FOOTPRINT as the underlying uppermost movable step rung of the tray-extension unit as suggested in FIG. 3;

FIG. 2A is an enlarged top plan view of the top tray of FIG. 1 showing that the top tray includes a shelf formed to include an article-receiving cavity and a perimeter rim that extends around the shelf and showing that the perimeter rim includes a back wall-engagement shield having separate first and second corner-lean surfaces that are angled to mate with first and second walls that cooperate to form a corner of a room to allow the extensible ladder of FIGS. 1 and 2 to lean against those two walls in the corner of the room as suggested in FIGS. 19, 20, and 25 and a medial wall-lean surface that is angled to mate with the first wall to allow the extensible ladder to lean against that wall as suggested in FIGS. 16-18 and a similar front wall-engagement shield having similar alternative corner-lean and medial wall-lean surfaces;

FIG. 2B is an enlarged sectional view taken along line 2B-2B of FIG. 2A;

FIG. 3 is a top plan view of the ladder in the COLLAPSED-STORAGE mode of FIG. 1 after the top tray has been separated from the free end of a small-diameter top tubular leg segment of the left telescoping leg and from the free end of a small-diameter top tubular leg segment of the right telescoping leg to show that the effective length and width of the top tray is substantially the same as the effect length and width of the underlying uppermost movable step rung that is mounted on the uppermost medial tubular leg segments of the left and right telescoping legs as suggested in FIG. 2 to cause the top tray to have the same FOOTPRINT as the underlying movable step rung of the variable-length tray-extension unit;

FIG. 3A is a perspective view of the ladder components shown in FIG. 3 suggesting downward movement of the separated top tray to mate with laterally spaced-apart upstanding free ends of the top tubular leg segments of the left and right telescoping legs and suggesting (with further reference to FIG. 2) that each of the movable step rungs includes a left plank collar associated with the left telescoping leg and formed to include a left leg mount, a right plank collar associated with the right telescoping leg and formed to include a right leg mount, a step comprising a plank extending between the companion left and right plank collars and an upwardly facing convex step tread coupled to a companion underlying plank, an ergonomic left finger grip cantilevered to the left plank collar and arranged to extend outwardly (to the left) from the step and an ergonomic right finger grip cantilevered to the right plank collar and arranged to extend outwardly (to the right) away from the step;

FIGS. 4-9 show various views of the top tray shown in FIGS. 1-3;

FIG. 4 is a perspective view of the top tray of FIG. 1;

FIG. 5 is a top plan view of the top tray of FIG. 4;

FIG. 6 is a left-end elevation view of the top tray of FIG. 4;

FIG. 7 is a right-end elevation view of the top tray of FIG. 4;

FIG. 8 is a front elevation view of the top tray of FIG. 4;

FIG. 9 is a rear elevation view of the top tray of FIG. 4;

FIGS. 10-15 show various views of the exposed and uppermost movable step rung shown in FIGS. 3 and 3A to underlie the separated top tray;

FIG. 10 is a perspective view of the uppermost movable step rung of FIG. 3A;

FIG. 11 is a top plan view of the uppermost movable step rung of FIG. 10;

FIG. 12 is a left-end elevation view of the uppermost movable step rung of FIG. 10;

FIG. 13 is a right-end elevation view of the uppermost movable step rung of FIG. 10;

FIG. 14 is a front elevation view of the uppermost movable step rung of FIG. 10;

FIG. 15 is a rear elevation view of the uppermost movable step rung of FIG. 10;

FIG. 15A is a perspective view of a portion of the left end of the extensible ladder in the COLLAPSED-STORAGE mode shown in FIG. 1 to illustrate the configuration of each of the ergonomic left finger grips included at the left end of each of the step rungs in the variable-length tray-extension unit to provide finger-receiving means for receiving fingers of an operator to facilitate gripping of the left end of each step rung to lift the step rung upwardly away from the left foundation during an initial stage of a mode change from the COLLAPSED-STORAGE mode shown in FIG. 1 to the EXTENDED-USE mode shown in FIG. 2;

FIG. 16 is an enlarged perspective view of an upper portion of the extensible ladder of FIG. 2 in the EXTENDED-USE mode leaning against a vertical wall and showing that the top tray includes a back wall-engagement shield that extends downwardly from a top edge of the top tray and includes a flat wall-lean surface that is arranged to mate with an exterior surface of the vertical wall when the ladder is leaned against that wall;

FIG. 16A is a sectional view of the upper portion of the leaning ladder taken along line 16A-16A of FIG. 16 showing the orientation of the top tray when the back wall-engagement shield of the top tray mates with the exterior surface of the vertical wall;

FIG. 17 is a left-side elevation of the upper portion of the leaning ladder of FIG. 16;

FIG. 18 is a top plan view of the leaning ladder of FIG. 17;

FIG. 19 is a perspective view of an upper portion of the extensible ladder of FIG. 2 in the EXTENDED-USE mode leaning in a corner established by two vertical walls that cooperate to form a right included angle therebetween;

FIG. 20 is a top perspective view of the leaning ladder in the corner shown in FIG. 19 to illustrate that a first (left) corner-lean surface included in the back wall-engagement shield included in the perimeter rim of the top tray is arranged to engage a first of the two vertical walls and a second (right) corner-lean surface in the back wall-engagement shield included in the perimeter of the top tray is arranged to engage a second of the two vertical walls when the ladder is leaned in a corner against two such walls;

FIG. 21 is an enlarged perspective view of an upper portion of the ladder shown in FIG. 1 showing that a left end of the perimeter rim of the top tray comprises, in series, left to right, a somewhat flag-shaped first corner-lean surface of the back wall-engagement shield, a first arcuate transition surface, and a somewhat flag-shaped first corner-lean surface of the front wall-engagement shield;

FIG. 22 is a top plan view of a corner formed by two walls and suggesting movement of the ladder of FIG. 2 to lean in the corner against the two walls and showing that a second corner-lean surface on the right side of the back wall-engagement shield has already mated with a second wall-contact zone included on a second of the two walls and suggesting that a first corner-lean surface on the left side of the front wall-engagement shield is moving toward a first wall-contact zone included on a first of the two walls;

FIG. 23 is an enlarged perspective view taken in the direction of line 23-23 of FIG. 22 showing the somewhat flag-shaped first corner-lean surface of the back wall-engagement shield of the perimeter rim of the top tray;

FIG. 24 is an enlarged elevation view taken in the direction of line 24-24 of FIG. 22 showing the first wall-contact zone outlined in phantom lines on a portion of the first of the two walls; and

FIG. 25 is a top plan view similar to FIG. 22 showing the ladder leaning in the corner following mating engagement of the first corner-lean surface of the back wall-engagement shield with the first wall-contact zone on the first wall and mating engagement of the second corner-lean surface of the back wall-engagement shield with the second wall-contact zone on the second wall.

### DETAILED DESCRIPTION

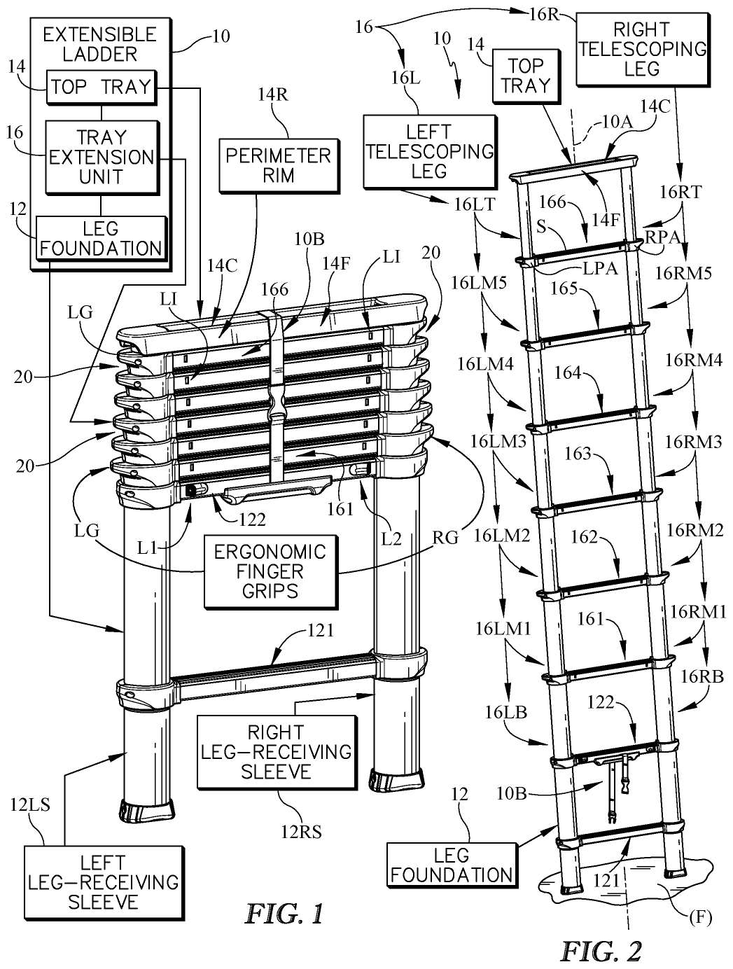

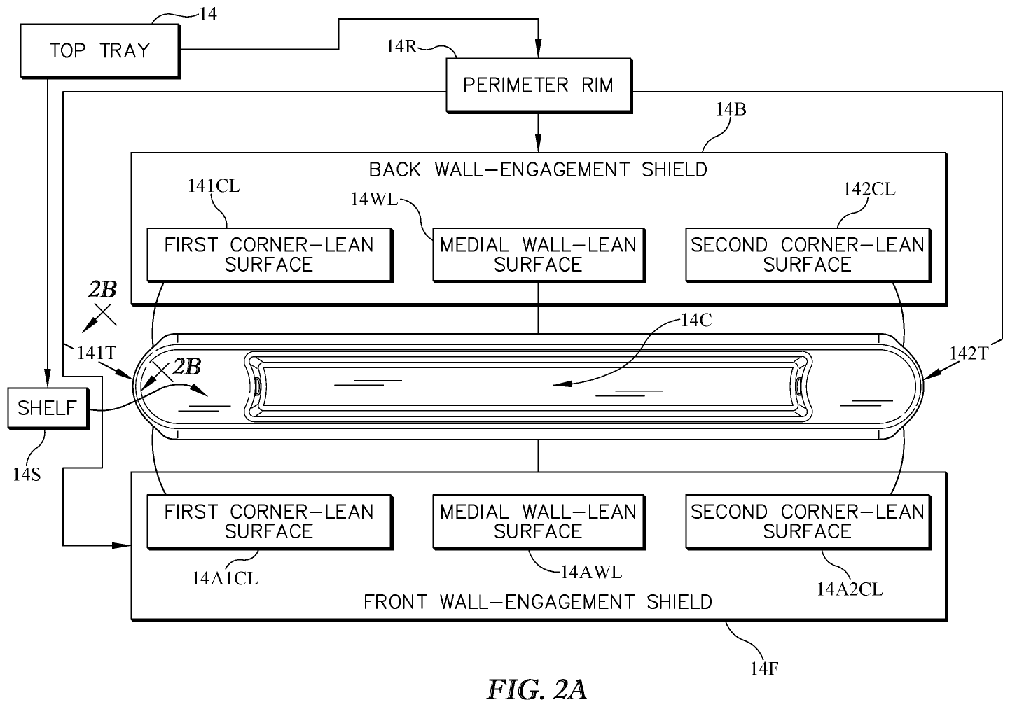

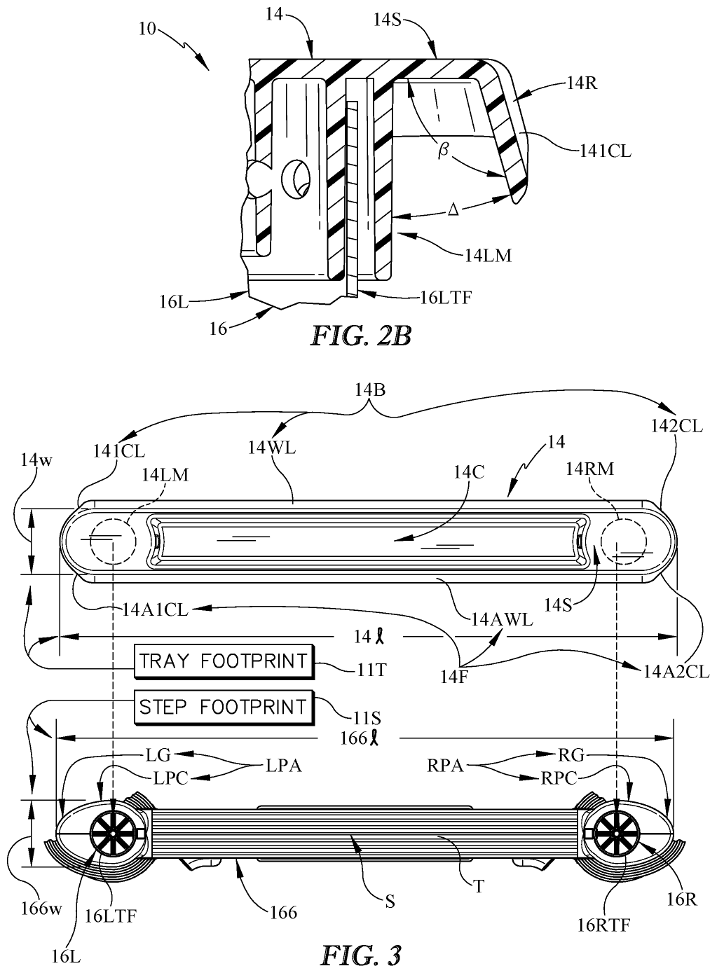

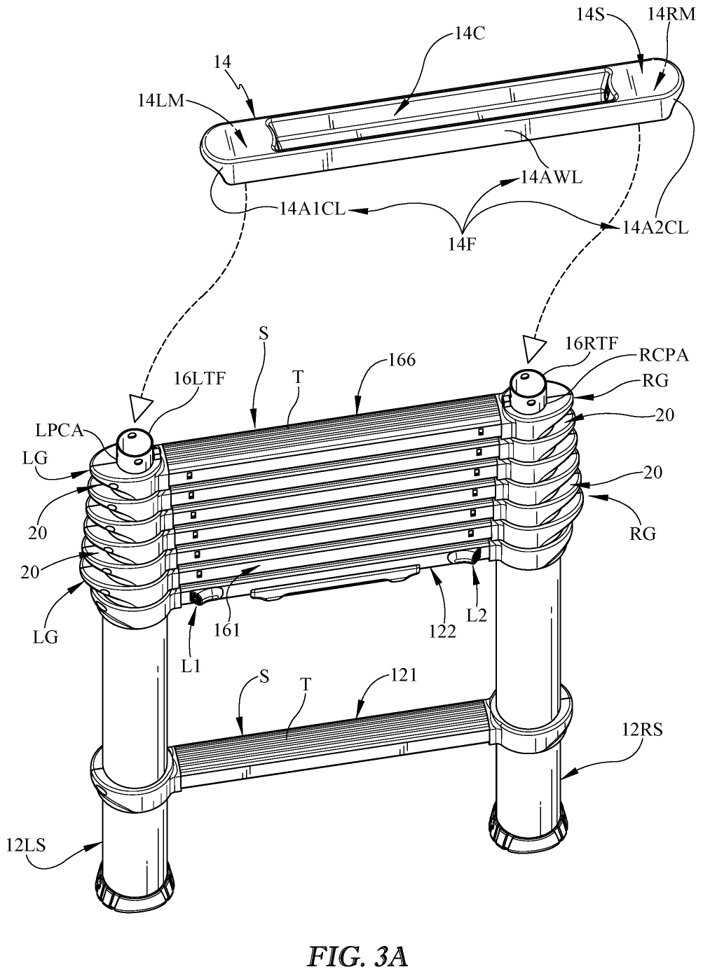

An extensible ladder 10 in accordance with the present disclosure can be expanded by a user from a COLLAPSED-STORAGE mode shown in FIG. 1 to an EXTENDED-USE mode shown in FIG. 2. Extensible ladder 10 includes a series of step rungs 161-166 as shown in FIGS. 1 and 2 and, in accordance with the present disclosure, each rung includes an ergonomic left finger grip (LG) at one end and an ergonomic right finger grip (RG) at an opposite end as suggested in FIG. 3A. An operator can use these grips (LG, RG) to move step rungs 161-166 relative to the floor (F) underlying extensible ladder 10 so as to change extensible ladder 10 from the COLLAPSED-STORAGE mode shown in FIG. 1 to the EXTENDED-USE mode shown in FIG. 2.

Extensible ladder 10 also includes a top tray 14 as shown in FIGS. 1-3A. Top tray 14 is formed to include an upwardly opening article-receiving cavity 14C and is sized in accordance with the present disclosure to have a TRAY FOOTPRINT 11T so as to fit within a STEP FOOTPRINT 11S established by the underlying uppermost movable step rung 166 as suggested in FIG. 3.

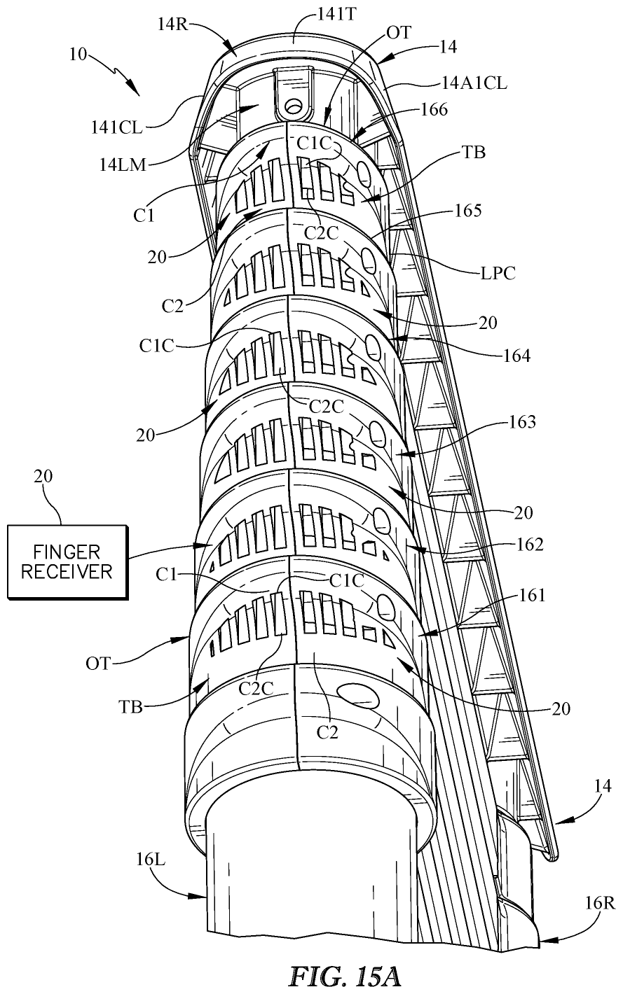

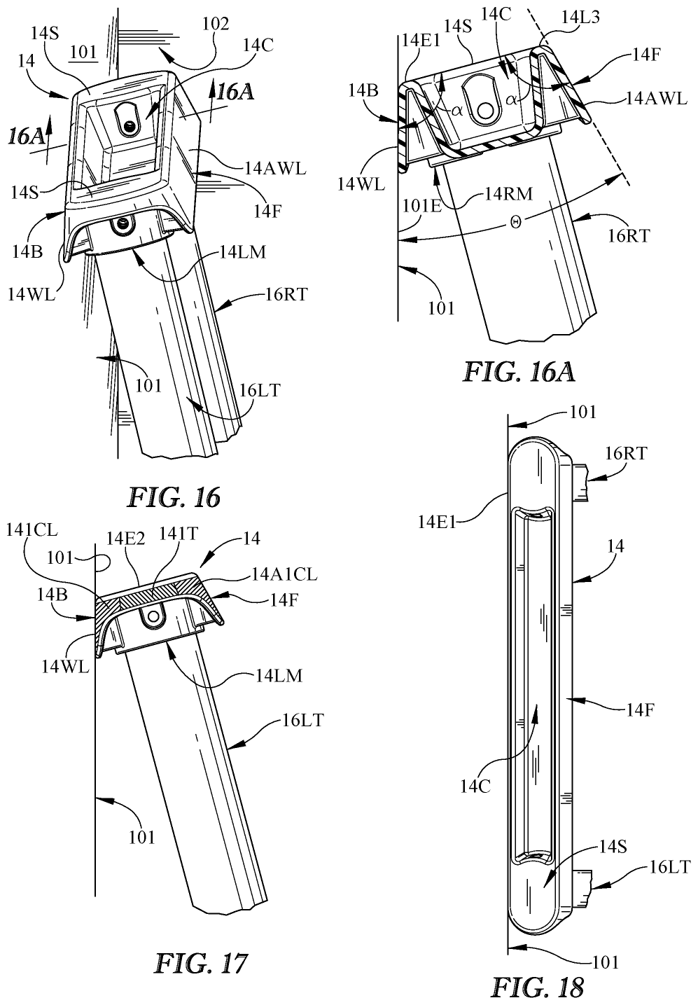

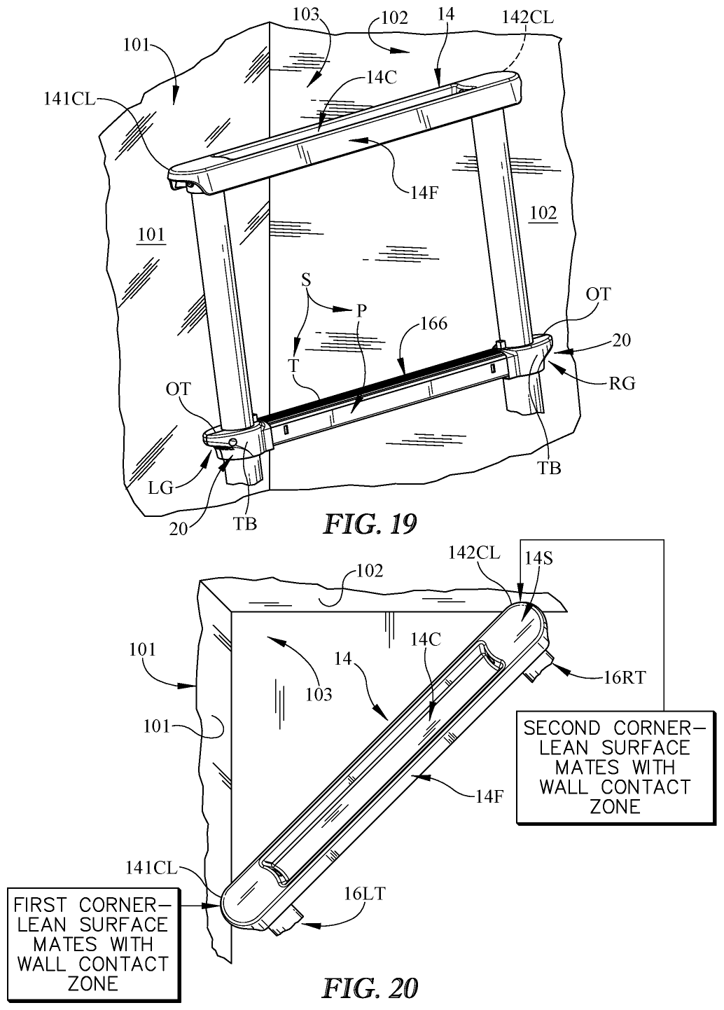

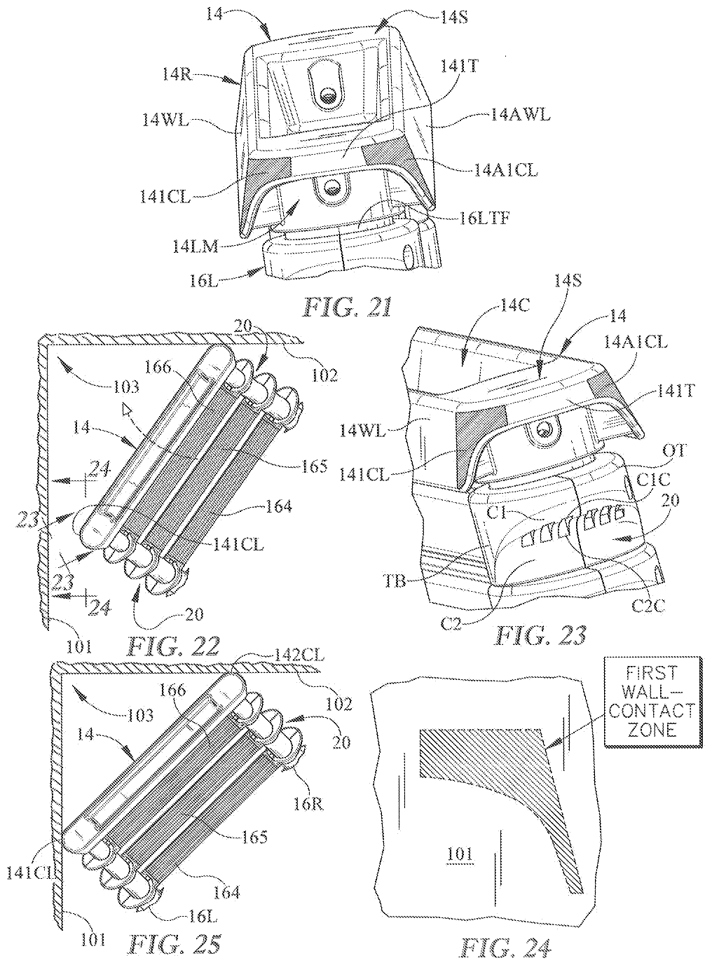

Top tray 14 includes a back wall-engagement shield 14B that has a medial wall-lean surface 14WL that is sized, shaped, and oriented to mate with an exterior surface 101E of a wall 101 when ladder 10 is leaned against wall 101 as suggested in FIGS. 16, 16A, 17, and 18. Back wall-engagement shield 14B also has two corner-lean surfaces 141CL, 142CL as shown in FIG. 2A that are sized, shaped, and oriented so that each of the corner-lean surfaces 141CL, 142CL mates with one of two adjacent corner-establishing walls 101, 102 to support ladder 10 when ladder 10 is leaned against walls 101, 102 in a corner 103 established by walls 101, 102 as suggested in FIGS. 19, 20, and 25.

Extensible ladder 10 includes a leg foundation 12, a top tray 14, and a variable- length tray-extension unit 16 that is arranged to interconnect leg foundation 12 and top tray 14 as suggested in FIG. 1. Leg foundation 12 is adapted to engage an underlying floor (F) as suggested in FIG. 2. Variable-length tray-extension unit 16 is configured to be expanded and contracted by an operator using finger receivers 20 provided by the ergonomic left and right finger grips (LG, RG) located on outer portions of step rungs 161-166 in accordance with the present disclosure as shown in FIGS. 1 and 15A to lengthen or shorten ladder 10 as desired by the operator.

Variable-length tray-extension unit 16 comprises left and right telescoping legs 16L, 16R that are shortened when the operator places extensible ladder 10 in the COLLAPSED-STORAGE mode as shown in FIG. 1 and that are lengthened when the operator places the extensible ladder 10 in the EXTENDED-USE mode as shown in FIG. 2. Ladder 10 also includes a belt 10B for temporarily retaining the variable-length tray-extension unit 16 in a COMPACT mode as shown in FIG. 1 when extensible ladder 10 is in COLLAPSED-STORAGE mode.

Extensible ladder 10 also includes a series of rungs shown, for example in FIG. 1. Leg foundation 12 includes, for example, first and second foundation rungs 121, 122 as shown in FIGS. 1 and 2. Tray-extension unit 16 includes, for example, six movable step rungs 161-166 as shown in FIG. 2. The uppermost movable step rung 166 underlies top tray 14 as shown in FIGS. 1 and 2 and has a STEP FOOTPRINT 11S that is substantially geometrically congruent with TRAY FOOTPRINT 11T of top tray 14 as shown in FIG. 3. Each step rung 161-166 includes an ergonomic left finger grip (LG) at one end and an ergonomic right finger grip (RG) at an opposite end in accordance with the present disclosure as shown in FIGS. 1, 3A and 10-15 to form finger receivers 20 to make it easy for an operator to grip and move step rungs 161-166 toward or away from one another during expansion or contraction of the variable-length extension unit 16 when extensible ladder 10 is collapsed for storage or extended for use.

Left telescoping leg 16L is shown in FIG. 2 to include, in series, large-diameter bottom tubular leg segment 16LB, first medial tubular leg segment 16LM1, second medial tubular leg segment 16LM2, third medial tubular leg segment 16LM3, fourth medial tubular leg segment 16LM4, fifth medial tubular leg segment 16LM5, and small-diameter top tubular leg segment 16LT. Each of these segments is hollow and has a different internal diameter and is formed to include a segment-receiving space sized to receive an adjacent nestable leg segment having a relatively smaller outer diameter. The leg segments have a decreasing size so that they can be placed inside one another as shown in FIGS. 1 and 3 when ladder 10 is in COLLAPSED-STORAGE mode. These nestable leg segments are extendable relative to one another when belt 10B is loosened to produce a usable ladder 10 when ladder 10 is in EXTENDED-USE mode as shown in FIG. 2.

Right telescoping leg 16R is shown in FIG. 2 to include, in series, large-diameter bottom tubular leg segment 16RB, first medial tubular leg segment 16RM1, second medial tubular leg segment 16RM2, third medial tubular leg segment 16RM3, fourth medial tubular leg segment 16RM4, fifth medial tubular leg segment 16RM5, and small-diameter top tubular leg segment 16RT. Right telescoping leg 16R has a similar construction to left telescoping leg 16L.

Leg foundation 12 includes hollow upright left and right leg-receiving sleeves 12LS, 12RS as shown in FIG. 1. As suggested in FIGS. 1 and 2, large-diameter bottom tubular segment 16LB of left telescoping leg 16L is sized to slide into and out of a segment-receiving space formed in upright left leg-receiving sleeve 12LS of leg foundation 12 during a mode change of extensible ladder 10. Similarly, large-diameter bottom tubular segment 16RB of right telescoping leg 16R is sized to slide into and out of a segment-receiving space formed in upright right leg-receiving sleeve 12RS of leg foundation 12 during a mode change of extensible ladder 10 as suggested in FIGS. 1 and 3.

Extensible ladder 10 is shown in an alternative EXTENDED-USE mode in FIG. 2. Extensible ladder 10 includes a leg foundation 12 adapted to engage an underlying floor (F), a top tray 14, and a variable-length tray-extension unit 16 including left and right telescoping legs 16L, 16R arranged to interconnect leg foundation 12 and top tray 14 and configured to be operated by a person to move top tray 14 relative to leg foundation 12 upwardly from a LOWERED position shown in FIG. 1 to a RAISED position shown in FIG. 2. When ladder 10 is leaned against a wall or other structure in the EXTENDED-USE mode, ladder 10 should be oriented to lie at about a 75° angle to the floor (F) on which leg foundation 12 of ladder 10 rests.

Left telescoping leg 16L includes a large-diameter bottom tubular segment 16LB that is sized to fit into an upright left leg-receiving sleeve 12LS, 12RS include in leg foundation 12 when ladder 10 is in the COLLAPSED-STORAGE mode as suggested in FIG. 1. A small-diameter top tubular leg segment 16LT having a free end 16LTF (shown in FIG. 3A) that is adapted to be coupled to a left side of top tray 14 is also included in left telescoping leg unit 16L along with five medial tubular leg segments 161LM1-5 of varying diameter arranged in series to interconnect the companion bottom and top tubular segments 16LB, 16LT as suggested in FIG. 2.

Right telescoping leg 16R includes a large-diameter bottom tubular segment 16RB that is sized to fit into an upright right leg-receiving sleeve 12RS included in leg foundation 12 when ladder 10 is in the COLLAPSED-STORAGE mode as suggested in FIG. 1. A small-diameter top tubular leg segment 16RT having a free end 16RTF (shown in FIG. 3A) that is adapted to be coupled to a right side of top tray 14 is also included in right telescoping leg unit 16R along with five medial tubular leg segments 161RM1-5 of varying diameter arranged in series to interconnect the companion bottom and top tubular segments 16RB, 16RT as suggested in FIG. 2. Leg foundation 12 further includes stationary first and second foundation rungs 121, 122 that are arranged to extend between and mate with the upright left and right leg-receiving sleeves 12LS, 12RS.

Conversion of extensible ladder 10 from the COLLAPSED-STORAGE mode shown in FIG. 1 to the EXTENDED-USE mode shown in FIG. 2 is initiated by pulling upwardly on top tray 14 while keeping leg foundation 12 in a relatively stationary position. This upward motion of top tray 14 causes variable-length tray-extension unit 16 to lengthen. In the EXTENDED-USE mode shown in FIG. 2, a leg-locking system (not shown) included in the extensible ladder 10 is activated to lock each of left and right telescoping legs 16L, 16R to retain legs 16L, 16R in the extended positions. An operator may actuate latches L1, L2 included in leg foundation 12 as shown in FIG. 1 to disable the leg-locking system to allow ladder 10 to be converted to the COLLAPSED-STORAGE MODE shown in FIG. 1. Indicators L1, L2 are provided in each of step rungs 161-166 to indicate whether the leg-locking system is enabled or disabled.

Extensible ladder 10 includes a series of movable step rungs 161-166 in tray-extension unit 16 as shown in FIGS. 1 and 2. Each movable step rung is mounted on a companion pair of tubular leg segments as shown in FIG. 2 to allow relative movements of the movable step rungs 161-166 from SIDE-BY-SIDE positions occupied in the COLLAPSED-STORAGE mode of ladder 10 as shown in FIG. 1 to SEPARATED positions occupied in the EXTENDED-USE mode of ladder 10 as shown in FIG. 2.

Ladder 10 is shown in FIG. 3 in the COLLAPSED-STORAGE mode after top tray 14 has been separated from free end 16LTF of small-diameter top tubular leg segment 16LT of left telescoping leg 16L and from free 16RTF end of small-diameter top tubular leg segment 16RT of right telescoping leg 16R to show that the effective length 14l and width 14w of top tray 14 is substantially the same as the effect length 166l and width 166w of the underlying uppermost movable step rung 166 that is mounted on the uppermost medial tubular leg segments 16LM5, 16RM5 of the left and right telescoping 16L, 16R legs as suggested in FIG. 2 As illustrated in FIG. 3 and suggested in FIG. 3A, top tray 14 has a TRAY FOOTPRINT 14T and the underlying uppermost movable step rung 166 has a STEP FOOTPRINT 14S that are substantially geometrically congruent in accordance with the present disclosure.

A perspective view of the ladder components shown in FIG. 3 is provided in FIG. 3A to suggest downward movement of the separated top tray 14 to mate with laterally spaced-apart upstanding free ends 16LTF, 16RTF of the top tubular leg segments 16LT, 16RT of the left and right telescoping legs 16L, 16R and suggesting (with further reference to FIG. 2) that each of the movable step rungs 161-166 includes a left plank collar (LPC) associated with the left telescoping leg 16L, a right plank collar (RPC) associated with the right telescoping leg 16R, a step (S) comprising a plank (P) extending between the companion left and right plank collars (LPC, RPC) and an upwardly facing convex step tread (T) coupled to a companion underlying plank (P), an ergonomic left finger grip (LG) cantilevered to the left plank collar (LPC) and arranged to extend outwardly (to the left) from the companion plank (P) to form a finger receiver 20, and an ergonomic right finger grip (RG) cantilevered to the right plank collar (RPC) and arranged to extend outwardly (to the right) away from the companion plank (P) to form a finger receiver 20. Left plank collar (LPC) is formed to include an end-receiving aperture (LPCA) for receiving the upstanding free end 16LTF of the top tubular segment 16LT as suggested in FIGS. 3, 3A, 10, and 11. Right plank collar (RPC) is formed to include an end-receiving aperture (RPCA) for receiving the upstanding free end 16RTF of top tubular segment 16RT as suggested in FIGS. 3, 3A, 10, and 11.

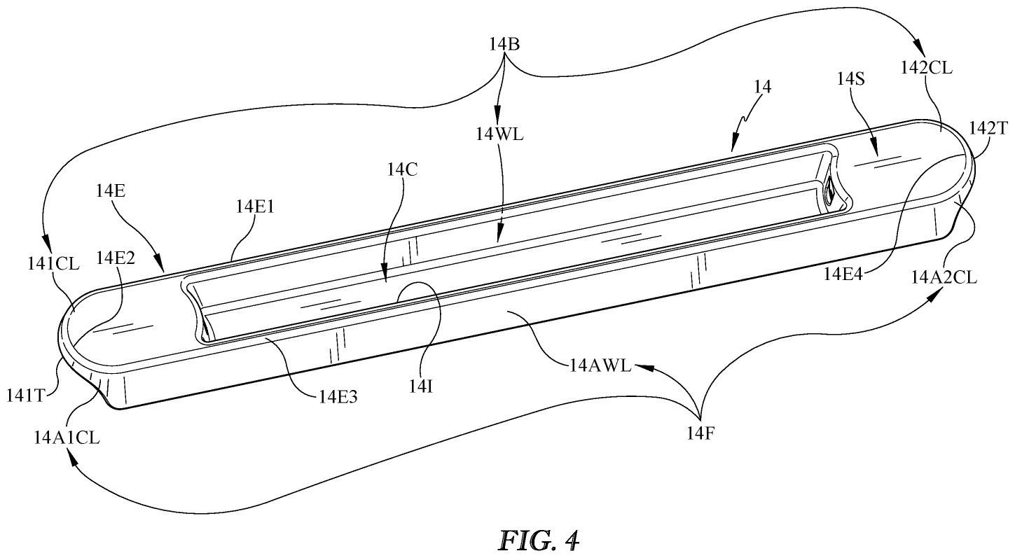

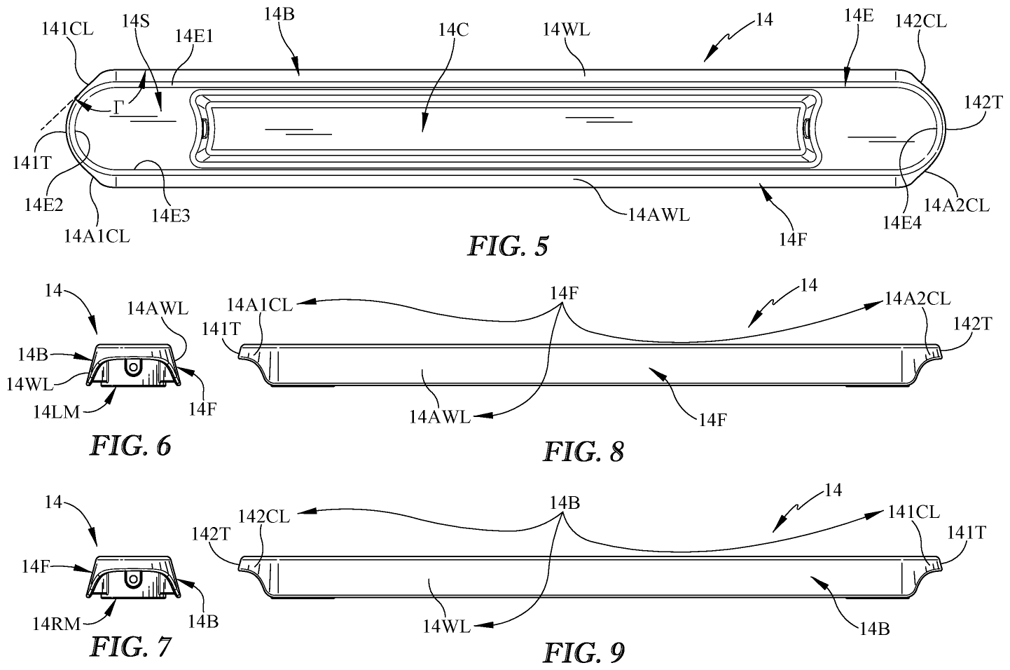

Top tray 14 includes an elongated shelf 14S and a perimeter rim 14R that extends around shelf 14S as shown, for example, in FIGS. 4 and 5. Perimeter rim 14R includes a back wall-engagement shield 14B that is configured in accordance with the present disclosure to engage a first wall 101 to support top tray 14 in a stable stationary position when ladder 10 is leaned against first wall 101 as shown, for example, in FIGS. 16, 16A, 17, and 18. Back wall-engagement shield 14B of perimeter rim 14R is also configured in accordance with the present disclosure to engage corner-establishing first and second walls 101, 102 to support top tray 14 in a stable stationary position when ladder 10 is leaned in a corner 103 against first and second walls 101, 102 that cooperate to form the corner 103 as shown, for example, in FIGS. 19, 20 and 25. Perimeter rim 14R also includes a front wall-engagement shield 14F that is similar to back wall-engagement shield 14B and is configured in accordance with the present disclosure to support top tray 14 in a stable stationary position when ladder 10 is rotated 180° about a vertical axis 10A (see FIG. 2) of ladder 10 to cause front wall-engagement shield 14F to face toward corner 103 and then leaned (1) against first wall 101 or (2) against corner-establishing first and second walls 101, 102 in corner 103.

Back wall-engagement shield 14B of perimeter rim 14R of top tray 14 includes a first corner-lean surface 141CL at one end, a second corner-lean surface 142CL at an opposite end, and a medial wall-lean surface 14WL interconnecting first and second corner-lean surfaces 141CL, 142CL as shown in FIGS. 1A and 5. Each of surfaces 141CL, 14WL, and 142CL is substantially flat as shown in FIG. 5 to mate with a companion flat wall 101 or 102 when a back side of ladder 10 is leaned against wall 101 as suggested in FIGS. 16-18 or in a corner 103 against corner-establishing walls 101, 102 as suggested in FIGS. 19, 20, and 25. Surfaces 141CL and 142CL while being substantially flat may be somewhat rounded.

Front wall-engagement shield 14F of perimeter rim 14R of top tray 14 includes an alternate first corner-lean surface 14A1CL at one end, an alternate second corner-lean surface 14A2CL at an opposite end, and an alternate medial wall-lean surface 14AWL interconnecting alternate first and second corner-lean surfaces 14A1CL, 14A2CL as shown in FIGS. 1A and 5. Each of surfaces 14A1CL, 14AWL, and 14A2CL is substantially flat as shown in FIG. 5 to mate with a companion flat wall 101 or 102 when ladder 10 is turned around about axis 10A to cause a front side of ladder 10 to be leaned only against wall 101 or against corner-establishing walls 101, 102 in corner 103. Surfaces 141CL and 142CL while being substantially flat may be somewhat rounded.

As suggested in FIG. 16A, medial wall-lean surface 14WL of back wall-engagement shield 14B of perimeter rim 14R of top tray 14 is oriented to lie at an obtuse angle α relative to shelf 14S. Similarly, alternate medial wall-lean surface 14WL of front wall-engagement shield 14F is also oriented to lie at an obtuse angle α relative to shelf 14S. The measure of angle α is about 105 degrees in an illustrative embodiment. As suggested in FIG. 16A, medial wall-lean surface 14WL of back wall-engagement shield 14B has a positive slope while alternate medial wall-lean surface 14AWL of front wall-engagement shield 14F has a negative slope to establish a dihedral included angle θ between medial wall-lean surfaces 14WL, 14AWL. The measure of angle θ is about 30 degrees in an illustrative embodiment.

As suggested in FIG. 2B, first corner-lean surface 141CL of back wall-engagement shield 14B of perimeter rim 14R of top tray 14 is oriented to lie at an obtuse angle β relative to shelf 14S. Second corner-lean surface 142CL of back wall-engagement shield 14B is also oriented to lie at an obtuse angle β relative to shelf 14S. The measure of angle β is about 105 degrees in an illustrative embodiment. The orientation of alternative first corner-lean surface 14A1CL of front wall-engagement shield 14F of perimeter rim 14R of top tray 14 relative to shelf 14S is the same as the orientation of first corner-lean surface 141CL. The orientation of alternative second corner-lean surface 14A2C1 relative to shelf 14S is the same as the orientation of second corner-lean surface 142CL.

In an illustrative embodiment shown in FIGS. 1A, 5 and 15A, perimeter rim 14R also includes a first arcuate transition surface 141T interconnecting free ends of first corner-lean surface 141CL of back wall-engagement shield 14B and alternate first corner-lean surface 14A1CL of front wall-engagement shield 14F. Perimeter rim 14R also includes a second arcuate transition surface 142T interconnecting free ends of second corner-lean surface 142CL of back wall-engagement shield 14B and alternate second corner-lean surface 14A2CL of front wall-engagement shield 14F.

Elongated shelf 14S of top tray 14 has an oblong outer perimeter edge 14E and is formed to include an upwardly opening article-receiving cavity 14C as shown, for example, in FIG. 4. Shelf 14S also includes an inner perimeter edge 14IE that is arranged to provide a boundary for the upwardly opening article-receiving cavity 14C as shown, for example, in FIG. 5.

As suggested in FIG. 5, oblong outer perimeter edge 14E of shelf 14S includes, in series, a first straight section 14E1 that is appended to a top edge of back wall-engagement shield 14B of top tray 14, a first curved section 14E2 that is appended to a top edge of surfaces 141CL, 141T, and 14A1CL, a second straight section 14E3 that is appended to a top edge of front wall-engagement shield 14F, and a second curved section 14E4 that is appended to a top edge of surfaces 14A2CL, 142T, and 142CL.

Top tray 14 also includes a cylindrical downwardly opening and extending left leg mount 14LM on one side of elongated shelf 14S as shown in FIG. 6 and a cylindrical downwardly opening and extending right leg mount 14RM on an opposite side of elongated shelf 14S as shown in FIG. 7. Left leg mount 14LM is sized to receive free end 16LTF of small-diameter top tubular segment 16LT of left telescoping leg 16L as suggested in FIGS. 3 and 3A, and 16. Right leg mount 14 14RM is sized to receive free end 16RFT of small-diameter top tubular segment 16RT of right telescoping leg 16RR when top tray 14 is mounted on right telescoping leg 16R as suggested in FIGS. 3, 3A, and 16A.

Ergonomic left finger grip (LG) of each movable step rung 161-166 is configured to be gripped easily by a user during a change in ladder 10 between COLLAPSED-STORAGE mode and EXTENDED-USE mode. Likewise, ergonomic right finger grip (RG) of each movable step rung 161-166 is configured to be gripped easily by a user during a change in ladder 10 between COLLAPSED-STORAGE mode and EXTENDED-USE mode. Each finger grip (LG, RG) includes an outboard tab (OT) and a tab buttress (TB) under outboard tab (OT) as shown, for example, in FIGS. 12-15A. The underside of tab buttress (TB) is cut away to form finger-receiving means 20 for receiving one or more fingers of an operator when that operator grips a companion finger grip (LG or RG) to facilitate movement of each step rung 161-166 upwardly or downwardly relative to leg foundation 12 during a change in ladder 10 between the COLLAPSED-STORAGE mode and the EXTENDED-USE mode.

An extensible ladder 10 includes a leg foundation 12, a top tray 14, and a variable-length tray-extension unit 16 as shown in FIGS. 1 and 2. Leg foundation 12 is adapted to engage an underlying floor (F) to support extensible ladder 10. Top tray 14 is formed to include an upwardly opening article-receiving cavity 14C. Variable-length tray-extension unit 16 is arranged to interconnect leg foundation 12 and top tray 14. Variable-length tray-extension unit 16 is configured (1) to be contracted in height to establish a COLLAPSED-STORAGE mode of extensible ladder 10 as shown in FIG. 1 in which top tray 14 is positioned to lie at a first distance from leg foundation 12 and movable step rungs 161-166 included in variable-length tray-extension unit 16 occupy side-by-side positions and (2) to be expanded in height to establish an alternative EXTENDED-USE mode as shown in FIG. 2 in which top tray 14 is elevated at a relatively greater second distance away from leg foundation 12 and the movable step rungs 161-166 included in variable-length tray-extension unit 16 are separated vertically from one another to support a user climbing the extensible ladder 10 to reach the elevated top tray 14.

Variable-length tray-extension unit 16 includes left and right telescoping legs 16L, 16R as shown in FIG. 2. Left telescoping leg 16L has a foundation end coupled to leg foundation 12 and an upwardly extending opposite free end 16LTF as shown in FIG. 3A. Right telescoping leg 16R lies in spaced-apart parallel relation to left telescoping leg 16L. Right telescoping leg 16R has a foundation end coupled to leg foundation 12 and an upwardly extending opposite free end 16RTF as also shown in FIG. 3A. Each of the movable step rungs 161-166 has a left portion coupled to one of several nestable leg segments 161LM1-5 included in left telescoping leg 16L and a right portion coupled to a companion one of several nestable leg segments 161RM1-5 included in right telescoping leg 16R as suggested in FIG. 2.

Top tray 14 includes a downwardly opening left leg mount 14LM sized as suggested in FIGS. 2B, 3, 3A, and 21 to receive the upwardly extending opposite free end 16LTF of the left telescoping leg 14L of the variable-length tray extension unit 16 therein to anchor a left side of top tray 14 to 14L left telescoping leg 16L. Top tray 14 also includes a downwardly opening right leg mount 14RM sized as suggested in FIGS. 3 and 3A to receive the upwardly extending opposite free end 16RTF of the right telescoping leg 16R of the variable-length tray-extension unit 16 therein to anchor a right side of top tray 14 to the right telescoping leg 14R.

An uppermost movable step rung 166 is included in the movable step rungs 161-166 of variable-length tray-extension unit 16 as shown in FIG. 3A. Uppermost movable step rung 166 is arranged to underlie top tray 14 so as to lie in side-by-side relation to top tray 14 in the COLLAPSED-STORAGE mode of extensible ladder 10 as shown in FIG. 1 and to lie in vertically separated relation to top tray 14 in the EXTENDED-USE mode of extensible ladder 10 as shown in FIG. 2.

The uppermost movable step rung 166 has a spacial STEP FOOTPRINT 11S established by an effective length 166l and width 166w thereof as shown in FIG. 3. Top tray 14 includes an elongated shelf 14S that includes an inner perimeter edge 14I that is arranged to provide a boundary for the upwardly opening article-receiving cavity 14C formed in top tray 14. Top tray 14 has a spacial TRAY FOOTPRINT 11T established by an effective length 14l and width 14w of the elongated shelf 11S as also shown in FIG. 3. STEP FOOTPRINT 11S and TRAY FOOTPRINT 11T are substantially geometrically congruent as shown in FIG. 3.

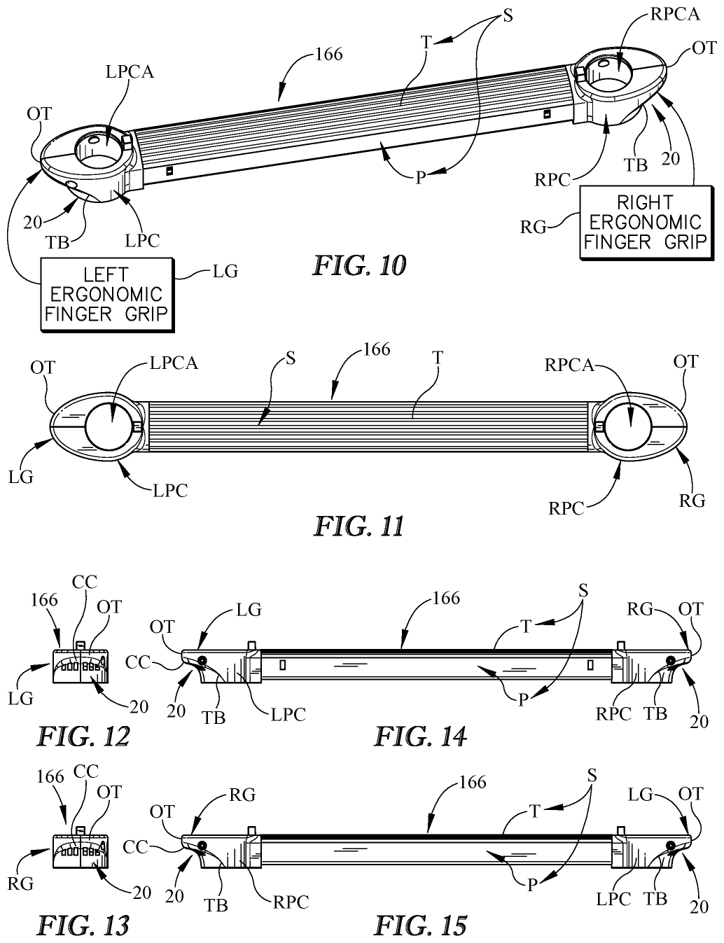

The uppermost movable step rung 166 includes a left plank anchor LPA adapted to be coupled to left telescoping leg 16L, a right plank anchor RPA adapted to be coupled to right telescoping leg 16R, and a step (S) as shown in FIGS. 2 and 10. Step (S) includes a plank (P) extending between and interconnecting the left and right plank anchors (LPA, RPA) and a step tread (T) coupled to plank (P) and arranged to lie between the left and right plank anchors (LPA, RPA) as shown in FIG. 10. The effective length 166l of the uppermost movable step rung 166 is measured from an outer end of left plank anchor (LPA) to an outer end of right plank anchor (RPA) as suggested in FIG. 3. The effective width 166w of the uppermost movable step rung 166 is a largest width of one of the left and right plank anchors (LPA, RPA) as suggested in FIG. 3.

Left plank anchor (LPA) includes a left plank collar (LPC) rigidly coupled to one end of the plank (P) and slidably coupled to the left telescoping leg 16L as suggested in FIGS. 2 and 10 to allow sliding movement of the left telescoping leg 16L relative to the left plank collar (LPC) during a mode change of the extensible ladder 10 between the COLLAPSED-STORAGE mode shown in FIG. 1 and the EXTENDED-USE mode shown in FIG. 2. Left plank anchor (LPA) also includes an ergonomic left finger grip (LG) cantilevered to left plank collar (LPC) as shown in FIG. 10. Ergonomic left finger grip (LG) is arranged to extend outwardly away from plank (P) above a movable step rung 165 underlying the uppermost movable step rung 166 to provide finger-receiving means 20 for receiving fingers of an operator between the ergonomic left finger grip (LG) and a left plank anchor (LPA) included in the underlying movable step rung 165 when extensible ladder 10 occupies the COLLAPSED-STORAGE mode as shown in FIGS. 1 and 3A to facilitate gripping of a left end of the uppermost movable step rung 166 during an initial stage of a mode change from the COLLAPSED-STORAGE mode of the extensible ladder 10 shown in FIG. 1 to the EXTENDED-USE mode of the extensible ladder 10 shown in Fib. 2 so that the operator manually may move the uppermost movable step rung 166 upwardly away from the underlying movable step rung 165 and the leg foundation 12.

Right plank anchor (RPA) includes a right plank collar (RPC) rigidly coupled to one end of the plank (P) and slidably coupled to the right telescoping leg 16R as suggested in FIGS. 2 and 10 to allow sliding movement of the right telescoping leg 16R relative to the right plank collar (RPC) during a mode change of the extensible ladder 10 between the COLLAPSED-STORAGE mode shown in FIG. 1 and the EXTENDED-USE mode shown in FIG. 2. Right plank anchor (RPA) also includes an ergonomic right finger grip (RG) cantilevered to right plank collar (RPC). Ergonomic right finger grip (RG) is arranged to extend outwardly away from plank (P) above a movable step rung 165 underlying the uppermost movable step rung 166 to provide finger-receiving means 20 for receiving fingers of an operator between the ergonomic right finger grip (RG) and a right plank anchor (RPA) included in the underlying movable step rung 165 when extensible ladder 10 occupies the COLLAPSED-STORAGE mode as shown in FIGS. 1 and 3A to facilitate gripping of a right end of the uppermost movable step rung 166 during an initial stage of a mode change from the COLLAPSED-STORAGE mode of the extensible ladder 10 shown in FIG. 1 to the EXTENDED-USE mode of the extensible ladder 10 shown in FIG. 2 so that the operator manually may move the uppermost movable step rung 166 upwardly away from the underlying movable step rung 165 and the leg foundation 12.

Each of the ergonomic left and right finger grips (LG, RG) includes an outboard tab (OT) coupled to left plank collar (LPC) and a tab buttress (TB) coupled to left plank collar (LPC) and an underside of outboard tab (OT) as shown in FIGS. 10 and 12-15. Tab buttress (TB) includes a concave surface (CC) oriented to face downwardly away from outer tab (OT) as shown in FIG. 15A.

Top tray 14 includes an elongated shelf 14S and a perimeter rim 14R as shown in FIG. 4. Shelf 14S includes an inner perimeter edge 14I that is arranged to provide a boundary for the upwardly opening article-receiving cavity 14C formed in top tray 14P. Perimeter rim 14R is coupled to an outer perimeter edge of the elongated shelf 14S and is arranged to extend around the elongated shelf 14S. Perimeter rim 14R includes a back wall-engagement shield 14B that extends along a length of the elongated shelf 14S.

Back wall-engagement shield 24B includes a medial wall-lean surface 14WL, a first corner-lean surface 141CL at a first end of medial wall-lean surface 14WL, and a second corner-lean surface 142CL at an opposite end of medial wall-lean surface 14WL as shown in FIG. 2A. Medial wall-lean surface 14WL of perimeter rim 14R of top tray 14 is configured to provide means for engaging a first wall 101 to support top tray 14 in a stationary position on first wall 101 when extensible ladder 10 in the EXTENDED-USE mode is leaned against first wall 101 as shown in FIGS. 16-18. First and second corner-lean surfaces 141CL, 142CL of perimeter rim 14R of top tray 14 cooperate to provide means for causing first corner-lean surface 141CL to engage first wall 101 and second corner-lean surface 142CL to engage a second wall 102 that cooperates with first wall 101 to form an interior corner 103 to support top tray 14 in a stationary positon on the first and second walls 101, 102 when extensible ladder 10 in the EXTENDED-USE mode is located in the interior corner 103 and leaned against corner-establishing first and second walls 101, 102.

Medial wall-lean surface 14WL of the back wall-engagement shield 14B as shown in FIGS. 19, 20, and 25 of top tray 14 is oriented to lie at an obtuse angle β having a measure of about 105 degrees to the elongated shelf 14 of top tray. Each of the first and second corner-lean surfaces 141CL, 142CL of back wall-engagement shield 14B of top tray 14 is oriented to lie at an obtuse angle α having a measure of about 105 degrees to the elongated shelf 14S of top tray 14. Medial wall-lean surface 14WL and first corner-lean surface 141CL cooperate to define therebetween a dihedral included angle Γ having a measure of about 135 degrees. An acute included angle Δ of about 15 of 16 degrees is provided between first corner-lean surface 141CL and left leg mount LM.

Perimeter rim 14R of top tray 14 further includes a front wall-engagement shield 14F arranged to lie in spaced-apart relation to back wall-engagement shield 14B to locate the elongated shelf 14S therebetween as suggested in FIGS. 2A and 5. Front wall-engagement shield 14F includes an alternate medial wall-lean surface 14AWL, an alternate first corner-lean surface 14A1CL at a first end of medial wall-lean surface 14AWL, and an alternate second corner-lean surface 14A2CL at an opposite end of medial wall-lean surface 14AWL. Alternate wall-lean surface 14AWL of the front wall-engagement shield 14B of perimeter rim 14R of top tray 14 is configured to provide means for engaging a first wall 101 as shown in FIGS. 16-18 to support top tray 14 in a stationary position on first wall 14 when extensible ladder 10 in the EXTENDED-USE mode is leaned against first wall 101. Alternate first and second corner-lean surface 14A1CL, 14A2CL of the front wall-engagement shield 14F of perimeter rim 14R of top tray 14 cooperate to provide means for causing alternate first corner-lean surface 14A1CL to engage first wall 101 and alternate second corner-lean surface 14A2CL to engage the second wall 102 that cooperates with first wall 101 to form the interior corner 103 to support top tray 14 in a stationary position on first and second walls 101, 102 when extensible ladder 10 in the EXTENDED-USE mode is located in interior corner 103 and leaned against corner-establishing first and second walls 101, 102 as shown in FIGS. 19, 20, and 25.

Medial wall-lean surface 14AWL of back wall-engagement shield 14B of perimeter rim 14R of top tray 14 has a positive slope as suggested in FIG. 6. Medial wall-lean surface 14AWL of front wall-engagement shield 14F of perimeter rim 14R of top tray 14 has a negative slope as suggested in FIG. 6. Medial wall-lean and alternate medial wall-lean surfaces 14WL, 14AWL cooperate to establish a dihedral included angle Θ having a measure of about 30 degrees therebetween as shown in FIG. 16A.

Each of the movable step rungs 161-166 included in variable-length tray-extension unit 16 includes a left collar (LPC) associated with left telescoping leg 16L included in variable-length tray-extension unit 16, a right collar (RPC) associated with right telescoping leg 16R included in variable-length tray-extension unit 16, and a step (S) extending between and interconnecting left and right collars (LPC, RPC) as suggested in FIGS. 2 and 3. Each of the movable step rungs 161-166 also includes an ergonomic left finger grip (LG) cantilevered to left collar (LPC) and arranged to extend outwardly in a first direction away from step (S) and an ergonomic right finger grip (RG) cantilevered to right collar (RPC) and arranged to extend outwardly in an opposite second direction away from step (S) as suggested in FIGS. 10 and 11.

Each ergonomic left finger grip (LG) includes an outboard tab (OT) coupled to left collar (LPC) and a tab buttress (TB) as shown in FIGS. 10-12, 14, and 15A. Tab buttress (TB) is arranged to underlie outboard tab (OT) and coupled to left collar (LPC) and to an underside of outboard tab (OT). Tab buttress (TB) is also arranged to cooperate with left collar (LPC) to provide cavity means 20 for receiving fingers of an operator under tab buttress (TB) and alongside left collar (LPC) to facilitate manual gripping of a left end of an associated movable step rung and subsequent movement of the associated movable step rung relative to the left telescoping leg 16L during a mode change of the extensible ladder 10 between a COLLAPSED-STORAGE mode shown in FIG. 1 and an EXTENDED-USE mode shown in FIG. 2.

Tab buttress (TB) includes a downwardly facing curved surface C1 as shown in FIG. 15A. Left collar (LPC) includes a radially outwardly facing curved surface C2 that cooperates with the downwardly facing curved surface C1 of tab buttress (TB) to form the cavity means 20 as suggested in FIG. 15A. The downwardly facing curved surface C1 is interrupted by a series of laterally spaced-apart downwardly opening finger-grip channels C1C as shown in FIG. 15A. The radially outwardly facing curved surface C2 is interrupted by a series of vertically extending, circumferentially spaced-apart, outwardly opening finger-grip channels C2C as shown in FIG. 15A. The downwardly facing curved surface C1 is concave and the radially outwardly facing curved surface C2 is convex as shown in FIG. 15A.

1. An extensible ladder comprising
a leg foundation that is adapted to engage an underlying floor to support the extensible ladder,
a top tray formed to include an upwardly opening article-receiving cavity, and
a variable-length tray-extension unit arranged to interconnect the leg foundation and the top tray and configured to be contracted in height to establish a collapsed-storage mode of the extensible ladder in which the top tray is positioned to lie at a first distance from the leg foundation and movable step rungs included in the variable-length tray-extension unit occupy side-by-side positions and to be expanded in height to establish an alternative extended-use mode in which the top tray is elevated at a relatively greater second distance away from the leg foundation and the movable step rungs included in the variable-length tray-extension unit are separated vertically from one another to support a user climbing the extensible ladder to reach the top tray,
wherein the variable-length tray-extension unit includes a left telescoping leg having a foundation end coupled to the leg foundation and an upwardly extending opposite free end and a right telescoping leg lying in spaced-apart parallel relation to the left telescoping leg and having a foundation end coupled to the leg foundation and an upwardly extending opposite free end, each of the movable step rungs has a left portion coupled to one of several nestable leg segments included in the left telescoping leg and a right portion coupled to a companion one of several nestable leg segments included in the right telescoping leg, and
wherein the top tray includes a downwardly opening left leg mount sized to receive the upwardly extending opposite free end of the left telescoping leg of the variable-length tray extension unit therein to anchor a left side of the top tray to the left telescoping leg and a downwardly opening right leg mount sized to receive the upwardly extending opposite free end of the right telescoping leg of the variable-length tray-extension unit therein to anchor a right side of the top tray to the right telescoping leg.

2. The extensible ladder of claim 1, wherein an uppermost movable step rung is included in the movable step rungs of the variable-length tray-extension unit and arranged to underlie the top tray so as to lie in side-by-side relation to the top tray in the collapsed-storage mode of the extensible ladder and to lie in separated relation to the top tray in the extended-use mode of the extensible ladder, the uppermost movable step rung has a spacial step footprint established by an effective length and width thereof, and the top tray includes an elongated shelf that includes an inner perimeter edge that is arranged to provide a boundary for the upwardly opening article-receiving cavity formed in the top tray, and the top tray has a spacial tray footprint established by an effective length and width of the elongated shelf, and the step footprint and the tray footprint are substantially geometrically congruent.

3. The extensible ladder of claim 2, wherein the uppermost movable step rung includes a left plank anchor coupled to the left telescoping leg, a right plank anchor coupled to the right telescoping leg, a plank extending between and interconnecting the left and right plank anchors, and a step tread coupled to the plank and arranged to lie between the left and right plank collars, the effective length of the uppermost movable step rung is measured from an outer end of the left plank anchor to an outer end of the right plank anchor, and the effective width of the uppermost movable step rung is a largest width of one of the left and right plank anchors.

4. The extensible ladder of claim 3, wherein the left plank anchor includes a left plank collar rigidly coupled to one end of the plank and slidably coupled to the left telescoping leg to allow sliding movement of the left telescoping leg relative to the left plank collar during a mode change of the extensible ladder between the collapsed-storage mode and the extended-use mode and an ergonomic left finger grip cantilevered to the left plank collar and arranged to extend outwardly away from the plank above an underlying movable step rung underlying the uppermost movable step rung to provide finger-receiving means for receiving fingers of an operator between the ergonomic left finger grip and a left plank anchor included in the underlying movable step rung when the extensible ladder occupies the collapsed-storage mode to facilitate gripping of a left end of the uppermost movable step rung during an initial stage of a mode change from the collapsed-storage mode of the extensible ladder to the extended-use mode of the extensible ladder so that the operator may move the uppermost movable step rung upwardly away from the underlying movable step rung and the leg foundation.

5. The extensible ladder of claim 4, wherein the ergonomic left finger grip includes an outboard tab and a pair of downwardly facing concave finger-contact surfaces located under the outboard tab.

6. The extensible ladder of claim 4, wherein the right plank anchor includes a right plank collar rigidly coupled to one end of the plank and slidably coupled to the right telescoping leg to allow sliding movement of the right telescoping leg relative to the right plank collar during a mode change of the extensible ladder between the collapsed-storage mode and the extended-use mode and an ergonomic right finger grip cantilevered to the right plank collar and arranged to extend outwardly away from the plank above an underlying movable step rung underlying the uppermost movable step rung to provide finger-receiving means for receiving fingers of an operator between the ergonomic right finger grip and a right plank anchor included in the underlying movable step rung when the extensible ladder occupies the collapsed-storage position to facilitate gripping of a right end of the uppermost movable step rung during an initial stage of a mode change from the collapsed-storage mode of the extensible ladder to the extended-use mode of the extensible ladder so that the operator may move the uppermost movable step rung upwardly away from the underlying step rung and the leg foundation.

7. The extensible ladder of claim 6, wherein each of the ergonomic left and right finger grips includes an outboard tab coupled to the left plank collar and a tab buttress coupled to the left plank collar and an underside of the outboard tab and the tab buttress includes a concave surface oriented to face downwardly away from the outer tab.

8. The extensible ladder of claim 2, wherein the top tray includes an elongated shelf that includes an inner perimeter edge that is arranged to provide a boundary for the upwardly opening article-receiving cavity formed in the top tray and a perimeter rim that is coupled to an outer perimeter edge of the elongated shelf and is arranged to extend around the elongated shelf, and wherein the perimeter rim includes a back wall-engagement shield that extends along a length of the elongated shelf and includes a medial wall-lean surface, a first corner-lean surface at a first end of the medial wall-lean surface, and a second corner-lean surface at an opposite end of the medial wall-lean surface, the medial wall-lean surface of the perimeter rim of the top tray is configured to provide means for engaging a first wall to support the top tray in a stationary position on the first wall when the extensible ladder in the extended-use mode is leaned against the first wall, and the first and second corner-lean surfaces of the perimeter rim of the top tray cooperate to provide means for causing the first corner-lean surface to engage the first wall and the second corner-lean surface to engage a second wall that cooperates with the first wall to form an interior corner to support the top tray in a stationary positon on the first and second walls when the extensible ladder in the extended-use mode is located in the interior corner and leaned against the first and second walls.

9. The extensible ladder of claim 8, wherein the medial wall-lean surface of the back wall-engagement shield of the top tray is oriented to lie at an obtuse angle having a measure of about 105 degrees to the elongated shelf of the top tray.

10. The extensible ladder of claim 8, wherein each of the first and second corner-lean surfaces of the back wall-engagement shield of the top tray is oriented to lie at an obtuse angle having a measure of about 105 degrees to the elongated shelf of the top tray.

11. The extensible ladder of claim 8, wherein the medial wall-lean surface and the first corner-lean surface cooperate to define therebetween a dihedral included angle having a measure of about 135 degrees.

12. The extensible ladder of claim 8, wherein the perimeter rim further includes a front wall-engagement shield arranged to lie in spaced-apart relation to the back wall-engagement shield to locate the elongated shelf therebetween, the front wall-engagement shield includes an alternate medial wall-lean surface, an alternate first corner-lean surface at a first end of the medial wall-lean surface, and an alternate second corner-lean surface at an opposite end of the alternate medial wall-lean surface, the alternate medial wall-lean surface of the front wall-engagement shield of the perimeter rim of the top tray is configured to provide means for engaging a first wall to support the top tray in a stationary position on the first wall when the ladder in the extended-use mode is leaned against the first wall, and the alternate first and second corner-lean surface of the front wall-engagement shield of the perimeter rim of the top tray cooperate to provide means for causing the alternate first corner-lean surface to engage the first wall and the alternate second corner-lean surface to engage the second wall that cooperates with the first wall to form the interior corner to support the top tray in a stationary position on the first and second walls when the extensible ladder in the extended-use mode is located in the interior corner and leaned against the first and second walls.

13. The extensible ladder of claim 12, wherein the medial wall-lean surface of the back wall-engagement shield of the perimeter rim of the top tray has a positive slope, the medial wall-lean surface of the front wall-engagement shield of the perimeter rim of the top tray has a negative slope, and the medial wall-lean and alternate medial wall-lean surfaces cooperate to establish a dihedral included angle having a measure of about 30 degrees therebetween.

14. The extensible ladder of claim 1, wherein each of the movable step rungs included in the variable-length tray-extension unit includes a left collar associated with the left telescoping leg included in the variable-length tray-extension unit, a right collar associated with the right telescoping leg included in the variable-length tray-extension unit, a step extending between and interconnecting the left and right collars, an ergonomic left finger grip cantilevered to the left collar and arranged to extend outwardly in a first direction away from the step, and an ergonomic right finger grip cantilevered to the right collar and arranged to extend outwardly in an opposite second direction away from the step.

15. The extensible ladder of claim 14, wherein each ergonomic left finger grip includes an outboard tab coupled to the left collar and a tab buttress arranged to underlie the outboard tab and coupled to the left collar and to an underside of the outboard tab and arranged to cooperate with the left collar to provide cavity means for receiving fingers of an operator under the tab buttress and alongside the left collar to facilitate manual gripping of a left end of an associated movable step rung and subsequent movement of the associated movable step rung relative to the left telescoping leg during a mode change of the extensible ladder between a collapsed-storage mode and an extended-use mode.

16. The extensible ladder of claim 15, wherein the tab buttress includes a downwardly facing curved surface and the left collar includes a radially outwardly facing surface that cooperates with the downwardly facing curved surface of the tab buttress to form the cavity means.

17. The extensible ladder of claim 16, wherein the downwardly facing curved surface is interrupted by a series of laterally spaced-apart downwardly opening finger-grip channels.

18. The extensible ladder of claim 16, wherein the radially outwardly facing surface is interrupted by a series of vertically extending, circumferentially spaced-apart, outwardly opening finger-grip channels.

19. The extensible ladder of claim 16, wherein the downwardly facing curved surface is concave and the radially outwardly facing surface is convex.

20. The extensible ladder of claim 1, wherein the top tray includes an elongated shelf that includes an inner perimeter edge that is arranged to provide a boundary for the upwardly opening article-receiving cavity formed in the top tray and a perimeter rim that is coupled to an outer perimeter edge of the elongated shelf and is arranged to extend around the elongated shelf, and wherein the perimeter rim includes a back wall-engagement shield that extends along a length of the elongated shelf and includes a medial wall-lean surface, a first corner-lean surface at a first end of the medial wall-lean surface, and a second corner-lean surface at an opposite end of the medial wall-lean surface, the medial wall-lean surface of the perimeter rim of the top tray is configured to provide means for engaging a first wall to support the top tray in a stationary position on the first wall when the extensible ladder in the extended-use mode is leaned against the first wall, and the first and second corner-lean surfaces of the perimeter rim of the top tray cooperate to provide means for causing the first corner-lean surface to engage the first wall and the second corner-lean surface to engage a second wall that cooperates with the first wall to form an interior corner to support the top tray in a stationary positon on the first and second walls when the extensible ladder in the extended-use mode is located in the interior corner and leaned against the first and second walls.

21. The extensible ladder of claim 20, wherein the medial wall-lean surface of the back wall-engagement shield of the top tray is oriented to lie at an obtuse angle having a measure of about 105 degrees to the elongated shelf of the top tray.

22. The extensible ladder of claim 20, wherein each of the first and second corner-lean surfaces of the back wall-engagement shield of the top tray is oriented to lie at an obtuse angle having a measure of about 105 degrees to the elongated shelf of the top tray.

23. The extensible ladder of claim 20, wherein the medial wall-lean surface and the first corner-lean surface cooperate to define therebetween a dihedral included angle having a measure of about 135 degrees.

24. The extensible ladder of claim 20, wherein the perimeter rim further includes a front wall-engagement shield arranged to lie in spaced-apart relation to the back wall-engagement shield to locate the elongated shelf therebetween, the front wall-engagement shield includes an alternate medial wall-lean surface, an alternate first corner-lean surface at a first end of the alternate medial wall-lean surface, and an alternate second corner-lean surface at an opposite end of the alternate wall-lean surface, the alternate wall-lean surface of the front wall-engagement shield of the perimeter rim of the top tray is configured to provide means for engaging a first wall to support the top tray in a stationary position on the first wall when the ladder in the extended-use mode is leaned against the first wall, and the alternate first and second corner-lean surfaces of the front wall-engagement shield of the perimeter rim of the top tray cooperate to provide means for causing the alternate first corner-lean surface to engage the first wall and the alternate second corner-lean surface to engage the second wall that cooperates with the first wall to form the interior corner to support the top tray in a stationary position on the first and second walls when the extensible ladder in the extended-use mode is located in the interior corner and leaned against the first and second walls.
